(19) United States
(12) Patent Application Publication
(10) Pub. No.: US 2019/0299874 A1
(43) Pub. Date: Oct. 3, 2019

(54) SOUND VOLUME CONTROL DEVICE, SOUND VOLUME CONTROL METHOD AND PROGRAM

(71) Applicant: PIONEER CORPORATION, Bunkyo-ku, Tokyo (JP)

(72) Inventors: Akihiro ISEKI, Saitama (JP); Yusuke INOUE, Saitama (JP)

(21) Appl. No.: 16/317,474

(22) PCT Filed: Jul. 13, 2016
(86) PCT No.: PCT/JP2016/070732

§ 371 Date: Jan. 11, 2019

(51) Int. Cl. B60R 11/02; H04S 7/00; H04S 1/00; H04R 3/04; H04R 5/02; H04R 5/04

(52) U.S. Cl. CPC B60R 11/0217; B60R 11/0264; H04S 7/307; H04S 1/002; H04R 2430/01; H04R 5/02; H04R 5/04; H04S 2400/13; H04R 2499/13; H04R 3/04

(57) ABSTRACT

The sound volume control device is connected to output units symmetrically arranged with respect to left and right seats of a vehicle. The sound volume control device estimates a common frequency to be controlled when sounds outputted from each of the output units are listened to at each of listening positions of the left and right seats, and corrects a level at the common frequency based on the common frequency. Preferably, a frequency at which the direct sounds of the sounds outputted by each of the output units become in-phase at the listening positions of the left and right seats is determined as the common frequency based on the distances from each of the output units to one of the listening positions of the left and right seats.

### TECHNICAL FIELD

The present invention relates to a technique of adjusting sound that a listener listens in a vehicle compartment space.

### BACKGROUND TECHNIQUE

There are proposed technique of adjusting a sound pressure level of reproduced sound in an acoustic space such as a vehicle compartment. For example, Patent Reference-1 discloses a sound field control device including a plurality of speakers, a plurality of microphones, a mode division filter for mode-dividing sound pressure distribution, and a control filter for controlling input signals to the plurality of speakers such that a mode-amplitude of each of the divided modes becomes a predetermined value. This sound field control device measures the sound pressure distribution in an acoustic space, expresses the sound pressure distribution in the acoustic space by using a sine function and a cosine function of a space frequency in the mode subjected to the amplitude control, corrects the mode space frequency such that the expressed sound pressure distribution becomes equal to the measured sound pressure distribution, and determines filter coefficients of the mode-division filter based on the corrected mode space frequency.

### PRIOR ART REFERENCE

### Patent Reference

Patent Reference-1: Japanese Patent Application Laid-Open under No. 2009-159385

### SUMMARY OF THE INVENTION

### Problem to be Solved by the Invention

However, in the method of Patent Reference-1, it is necessary to execute large-scale calculation to analyze the frequency characteristics. Additionally, since the frequency characteristics are difference between the left and right seats in the vehicle compartment, it is difficult to determine the frequency band in which the sound needs to be corrected.

The above is an example of the problem to be solved by the present invention. It is an object of the present invention to provide a sound volume control device capable of controlling sound volume at left and right seats in the vehicle compartment at the same time, without the need of large-scale calculation.

### Means for Solving the Problem

An invention described in claims is a sound volume control device connected to output units symmetrically arranged with respect to left and right seats of a vehicle, comprising: an estimation unit configured to estimate a common frequency to be controlled when sounds outputted from each of the output units are listened to at each of listening positions of the left and right seats; and a correction unit configured to correct a level at the common frequency based on the common frequency.

Another invention described in claims is a sound volume control method executed by a sound volume control device connected to output units symmetrically arranged with respect to left and right seats of a vehicle, comprising: an estimation process configured to estimate a common frequency to be controlled when sounds outputted from each of the output units are listened to at each of listening positions of the left and right seats; and a correction process configured to correct a level at the common frequency based on the common frequency.

Still another invention described in claims is a program executed by a sound volume control device including a computer and connected to output units symmetrically arranged with respect to left and right seats of a vehicle, the program causing the computer to function as: an estimation unit configured to estimate a common frequency to be controlled when sounds outputted from each of the output units are listened to at each of listening positions of the left and right seats; and a correction unit configured to correct a level at the common frequency based on the common frequency.

### BRIEF DESCRIPTION OF THE DRAWINGS

FIGS. 1A and 1B illustrate an example of a vehicle compartment layout of a general sedan-type vehicle.

FIG. 2 schematically illustrates a configuration of a sound volume control device.

FIG. 3 illustrates a method of determining a controlled band based on the vehicle compartment layout.

FIG. 4 illustrates a frequency characteristic of direct sound in a typical vehicle.

FIG. 5 illustrates a frequency characteristic measured in a typical vehicle.

FIG. 6 illustrates sound pressure distributions at the FL seat before correction.

FIG. 7 illustrates sound pressure distributions at the FR seat before correction.

FIGS. 8A and 8B illustrate equalizer characteristics of a conventional example and an embodiment.

FIG. 9 illustrates sound pressure distributions at the FL seat after correction by the conventional example.

FIG. 10 illustrates sound pressure distributions at the FR seat after correction by the conventional example.

FIG. 11 illustrates sound pressure distributions at the FL seat after correction by the embodiment.

FIG. 12 illustrates sound pressure distributions at the FR seat after correction by the embodiment.

FIG. 13 illustrates an example of a configuration of an equalizer.

FIG. 14 is a flowchart of sound volume control processing.

### DETAILED DESCRIPTION OF THE PREFERRED EMBODIMENTS

According to one aspect of the present invention, there is provided a sound volume control device connected to output units symmetrically arranged with respect to left and right seats of a vehicle, comprising: an estimation unit configured to estimate a common frequency to be controlled when sounds outputted from each of the output units are listened to at each of listening positions of the left and right seats; and a correction unit configured to correct a level at the common frequency based on the common frequency.

The above sound volume control device is connected to output units symmetrically arranged with respect to left and right seats of a vehicle. The sound volume control device estimates a common frequency to be controlled when sounds outputted from each of the output units are listened to at each of listening positions of the left and right seats, and corrects a level at the common frequency based on the common frequency. Thus, it becomes possible to control the sound volume at the listening positions of the left and right seats at the same time.

In one mode of the above sound volume control device, the estimation unit estimates, as the common frequency, a frequency at which direct sounds of the sounds outputted from each of the output units become in-phase at each of the listening positions of the left and right seats. In this mode, the level is corrected at the frequency in which the direct sounds of the sounds outputted from the output units become in-phase and the sound pressure level becomes high.

In another mode of the above sound volume control device, the estimation unit estimates the common frequency based on distances from each of the output units to one of the listening positions of the left and right seats. Preferably, the estimation unit estimates the common frequency by an equation based on a difference of the distances. Thus, the sound volume at the left and right seats may be corrected without the need of performing measurement of the acoustic characteristic in the compartment or complicated calculation.

Still another mode of the above sound volume control device further comprises a phase controller configured to control phases of the sounds outputted from each of the output units to be in-phase at the left and right seats. In this mode, when the phase of the sound signals outputted from the output units is controlled, the common frequency is estimated for the sound signals after the phase control, and the level is corrected.

In still another mode of the above sound volume control device, the correction unit corrects the level in a frequency band having a predetermined range from the common frequency. Thus, the sound volume is controlled for a frequency band of a constant width having the common frequency as the center frequency.

In still another mode of the above sound volume control device, the correction unit does not correct the level for the common frequency higher than a predetermined frequency. In this mode, since the effect of correcting the level becomes small in a frequency band higher than a predetermined frequency band in view of a hearing sense of a human being, the correction of the level is not necessary.

According to another aspect of the present invention, there is provided a sound volume control method executed by a sound volume control device connected to output units symmetrically arranged with respect to left and right seats of a vehicle, comprising: an estimation process configured to estimate a common frequency to be controlled when sounds outputted from each of the output units are listened to at each of listening positions of the left and right seats; and a correction process configured to correct a level at the common frequency based on the common frequency.

According to still another aspect of the present invention, there is provided a program executed by a sound volume control device including a computer and connected to output units symmetrically arranged with respect to left and right seats of a vehicle, the program causing the computer to function as: an estimation unit configured to estimate a common frequency to be controlled when sounds outputted from each of the output units are listened to at each of listening positions of the left and right seats; and a correction unit configured to correct a level at the common frequency based on the common frequency. By executing the program by the computer, the above sound volume control device can be realized. This program may be handled in a manner stored in a storage medium.

### EMBODIMENTS

A preferred embodiment of the present invention will be described below with reference to drawings.

[Basic Principle]

First, a basic principle of a sound volume control according to the embodiment will be described. When sound is reproduced in a vehicle compartment, frequency bands having high sound pressure level and low sound pressure level are created at each seat in the vehicle compartment. Therefore, it is required to correct the sound pressure level in each frequency band at the left and right seats, e.g., the driver's seat and the assistant driver's seat in the vehicle compartment at the same time.

In this respect, the conventional method executes large-scale analysis of measured data acquired by using a plurality of speakers and a plurality of microphones to obtain a frequency characteristic, and applies correction processing to a particular frequency band by an equalizer based on the obtained frequency characteristic. Specifically, the conventional method corrects the sound pressure level to attenuate a peak in the frequency characteristic. However, since the frequency characteristic obtained by measuring the sound field in the vehicle compartment includes much sound reflected by interior walls of the vehicle compartment and structures (e.g., seats and a steering) in the vehicle compartment, the frequency characteristics at the left and right seats are different from each other. Therefore, it is not possible to achieve a robust adjustment by the correction based on the frequency characteristic measured in that way.

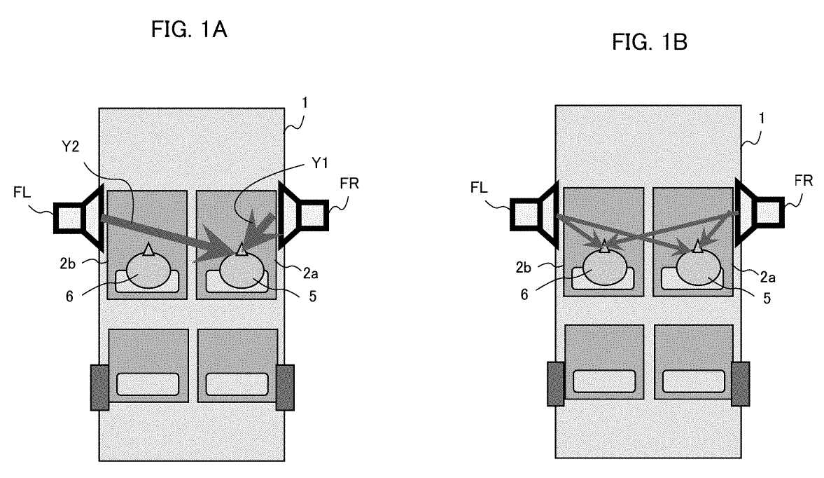

Accordingly, the embodiment of the present invention determines the frequency band in which the sound pressure level needs to be corrected, based on the layout of the vehicle compartment. In a general vehicle, the left and right seats are arranged almost symmetrically, and the left and right speakers are arranged symmetrically with respect to those two seats. FIGS. 1A and 1B illustrate an example of a vehicle compartment layout of a general sedan-type vehicle. Supposing that the vehicle 1 is a right-hand drive vehicle, a driver 5 sits on a driver's seat 2a, and a passenger 6 sits on an assistant driver's seat 2b. A right speaker FR is arranged on the right side of the driver's seat 2a, and a left speaker FL is arranged on the left side of the assistant driver's seat 2b.

As illustrated in FIG. 1A, to the listening position of the driver 5, i.e., the driver's seat 2a, the sound from the right speaker FR reaches as shown by the arrow Y1 and the sound from the left speaker FL reaches as shown by the arrow Y2. Here, there is a frequency band in which the sounds outputted from the two speakers become in-phase at the driver's seat 2a. The frequency band in which the sounds become in-phase is determined based on the distances from the two speakers to the driver's seat 2a, more specifically based on the difference of the distances. In the frequency band in which the sounds from the left and right speakers become in-phase, the sounds from the two speakers emphasize each other and the sound pressure level becomes high.

As illustrated in FIG. 1B, this phenomenon also occurs at the assistant driver's seat 2b. Since the general vehicle compartment layout is symmetrical, the frequency at which the sounds from the two speakers become in-phase at the driver's seat 2a coincides with the frequency at which the sounds from the two speakers become in-phase at the assistant driver's seat 2b. Therefore, the frequency at which the sounds from the two speakers become in-phase is determined as a controlled frequency based on the vehicle compartment layout, and a frequency band of a predetermined width having the controlled frequency as its center frequency is determined as a controlled band. Then, by controlling the sound pressure level at the controlled band, the sound volume at the left and right seats can be controlled at the same time.

[Sound Volume Control Device]

(Configuration)

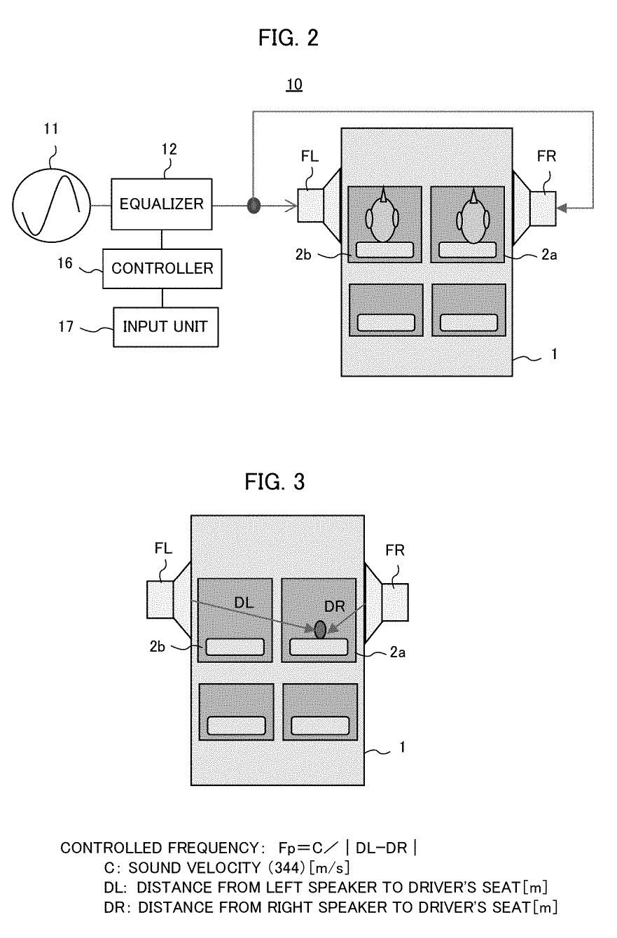

FIG. 2 schematically illustrates a configuration of a sound volume control device based on the above-described basic principle. In this embodiment, when the sounds are outputted from the left and right speakers arranged on the front doors with respect to the left and right speakers of the vehicle, the sound signal supplied to each speaker is attenuated at a specific controlled band.

Specifically, as illustrated in FIG. 2, the sound volume control device 10 includes a sound source 11, an equalizer 12, a controller 16, and an input unit 17. To the input unit 17, vehicle compartment layout information, specifically the distances from the left and right speakers FL and FR to the left and right seats is inputted by a user. The controller 16 may include a computer, and determines the controlled band based on the vehicle compartment layout information inputted to the input unit 17 in a manner described later, and sets the controlled band to the equalizer 12.

Meanwhile, the sound signal outputted from the sound source 11 is supplied to the equalizer 12. The equalizer 12 attenuates the level of the sound signal in the controlled band, and supplies the attenuated sound signal to the left and right speakers FL and FR, respectively. The left and right speakers FL and FR reproduce the supplied sound signal to output sound. Thus, the sound volume control device 10 of the embodiment can reduce the sound volume in the frequency band in which the sounds listened to at the left and right seats become large, without the need of complicated calculation. It is noted that the controller 16 is an example of an estimation unit of the present invention, and the equalizer 12 is an example of a correction unit of the present invention.

(Method of Determining Controlled Band)

Next, description will be given of a determination method of the controlled band in which the equalizer 12 attenuates the sound signal. FIG. 3 is a diagram explaining a method of determining the controlled band based on the vehicle compartment layout. The controlled frequency is a frequency at which the direct sounds outputted from two speakers become in-phase at the driver's seat 2a and the assistant driver's seat 2b. It is noted that the “direct sound” is sound which directly reaches the driver's seat 2a and the assistant driver's seat 2b from the speakers, and means to except the reflected sound by the interior walls of the vehicle compartment and the structures in the vehicle compartment.

Now, supposing that the driver's seat 2a is the listening position, the distance from the left speaker FL to the driver's seat 2a is “DL” and the distance from the right speaker FR to the driver's seat 2a is “DR”, the controlled frequency Fp is given as follows:

Fp=C/|DL−DR| (1)

Here, “C” is a sound velocity (344 m/s).

Supposing that the distance DL=1.4 m and the distance DR=1.1 m as an example of a typical vehicle, the controlled frequency Fp is as follows:

Fp=344/|1.4−1.1|≐1150 [Hz] (2)

Therefore, if a frequency band of a predetermined width having 1150 [Hz] as its center frequency is determined as the controlled band and the equalizer processing is applied to the controlled band, it becomes possible to control the sound field at the left and right seats at the same time. Since the vehicle compartment layout is symmetrical, the controlled frequency Fp calculated for the assistant driver's seat 2b becomes the same value. Preferably, the controlled band is set to the range of ±⅙ octave from the controlled frequency Fp serving as the center frequency. Namely, the equalizer 12 is set to attenuate the sound signal for the frequency band of ⅓ octave from the controlled frequency Fp serving as the center frequency.

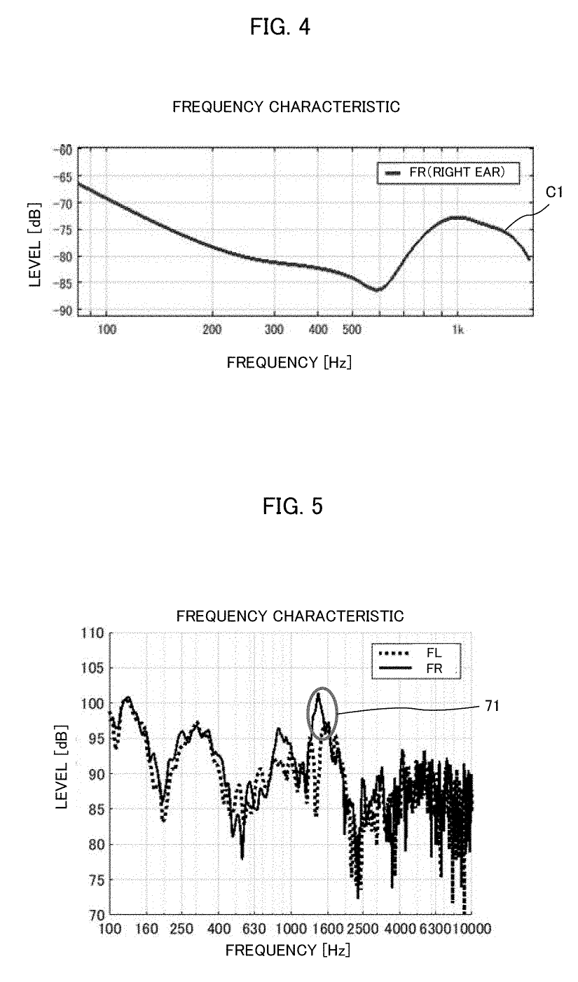

Next, description will be given as to why the above-described method of determining the controlled frequency based on the vehicle compartment layout, specifically the distances between the two speakers and the listening position is effective. FIG. 4 illustrates the frequency characteristic of the direct sound measured at the right ear position of the driver's seat in the vehicle of the above example (DL=1.4 m, DR=1.1 m). Namely, this frequency characteristic does not include the reflected sounds in the vehicle compartment. As shown, the frequency characteristic at the driver's seat has a dip around 600 Hz and a peak of a certain width around 1000 Hz. The dip is generated by the sounds from the two speakers which are in reverse phase and cancel out each other, and the peak is generated by the sounds from the two speakers which are in-phase and emphasize each other. The controlled frequency calculated by the above equation (2) is 1150 Hz, which almost coincides with the center of the peak in FIG. 4. In this way, by determining the controlled band based on the distances from the two speakers to the listening position, it becomes possible to determine the peak of the direct sounds, i.e., the center of the frequency band in which the sounds from the two speakers emphasize each other, as the controlled frequency, without being affected by the reflected sounds.

(Effect)

Next, the effect of the embodiment will be described in comparison with a conventional example. FIG. 5 illustrates frequency characteristics measured in the vehicle interior sound field before correction. In FIG. 5, the solid line graph indicates the frequency characteristic at the driver's seat (hereinafter referred to as “FR seat”), and the broken line graph indicates the frequency characteristic at the assistant driver's seat (hereinafter referred to as “FL seat”). These frequency characteristics are measured in the vehicle compartment of a typical sedan-type vehicle as shown in FIGS. 1A, 1B and 2, and include not only the direct sounds from the left and right speakers FL and FR to the left and right seats but also the components of the reflected sounds by the interior walls and the structures in the vehicle compartment.

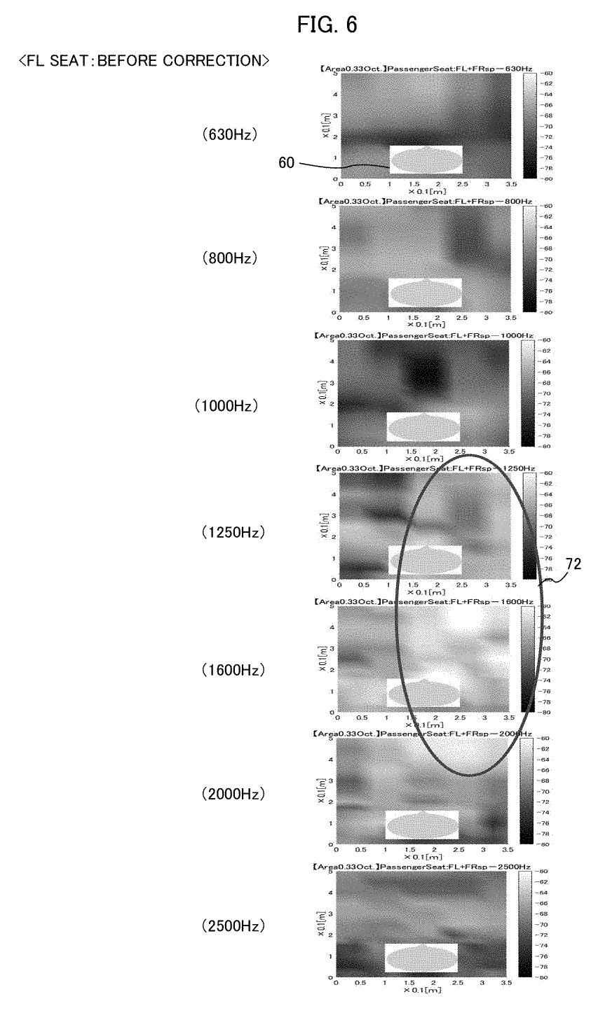

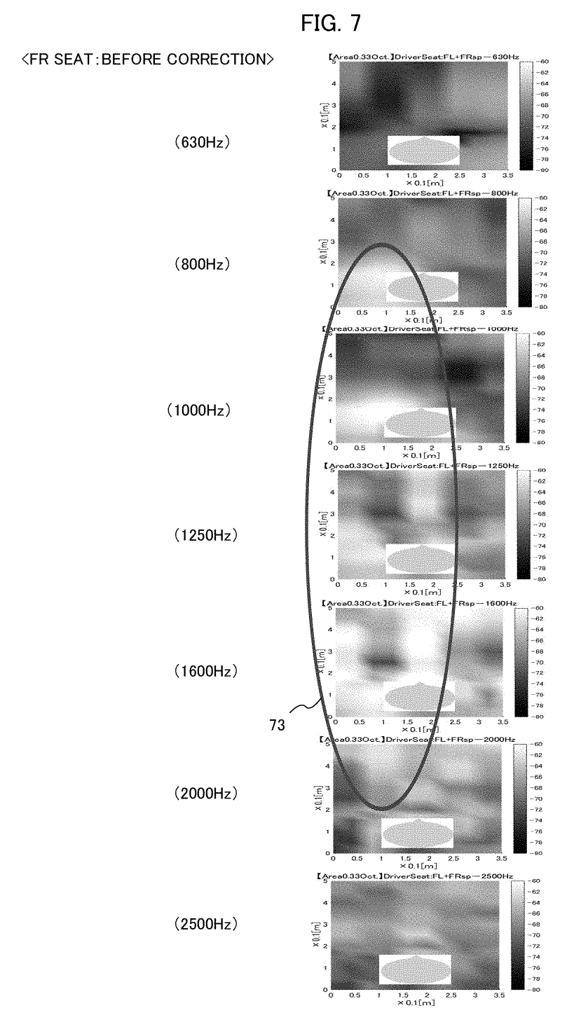

FIGS. 6 and 7 illustrate sound pressure distributions in each frequency band in the vehicle interior sound field before correction. FIG. 6 illustrates the sound pressure distributions at the FL seat, and FIG. 7 illustrates the sound pressure distributions at the FR seat. FIGS. 6 and 7 indicate the sound pressure level by the shade of colors, wherein the sound pressure level is low in the dark color area and the sound pressure level is high in the light color area.

The sound pressure distribution in each frequency band indicates the average of the sound pressure level for each ⅓ octave band having each frequency as its center frequency. Also, the rectangular area 60 in each sound pressure distribution indicates the face area of the listener sitting at the listening position. Namely, the rectangular area 60 in the sound pressure distribution of the FL seat indicates the face area of the passenger sitting at the assistant driver's seat, and the rectangular area 60 in the sound pressure distribution of the FR seat indicates the face area of the driver sitting at the driver's seat.

In the sound pressure distribution at the FL seat before correction, a high sound pressure level area is generated in the frequency band 1250-1600 Hz shown by the ellipse 72 in FIG. 6. In the sound pressure distribution at the FR seat before correction, a high sound pressure level area is generated in the frequency band 800-1600 Hz shown by the ellipse 73 in FIG. 7.

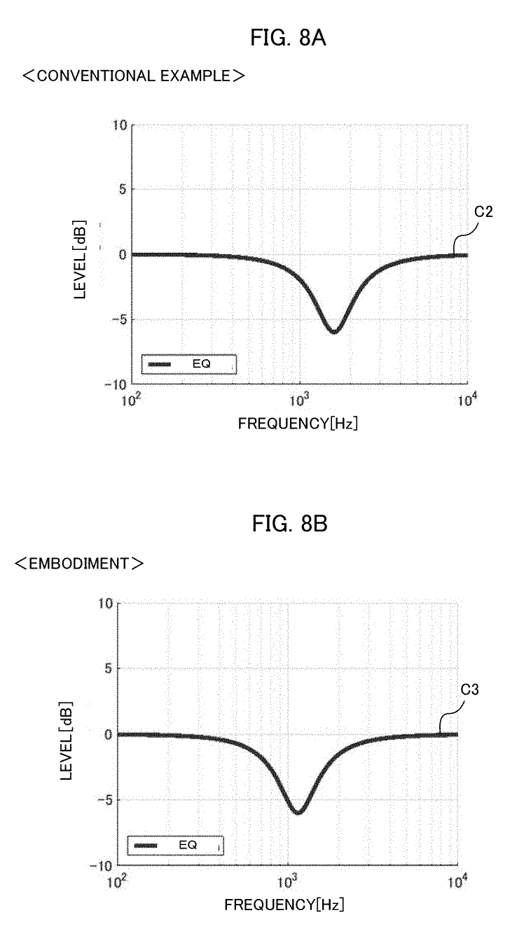

Next, the method of the conventional example will be described. As described above, by the method of the conventional example, the frequency characteristic in the vehicle interior sound field is measured by using the plurality of speakers and microphones, and the equalizer is applied to the peak frequency of the frequency characteristic to execute correction. The frequency characteristic of the vehicle interior sound field subjected to this time is shown in FIG. 5, wherein the characteristics at the FL seat and the FR seat show the value close to the peak in the frequency band shown by the ellipse 71. Therefore, by the method of the conventional example, the frequency band shown by the ellipse 71, i.e., the frequency band around 1600 Hz is attenuated by the equalizer. Specifically, the equalizer having the characteristic shown in FIG. 8A is applied in the conventional method.

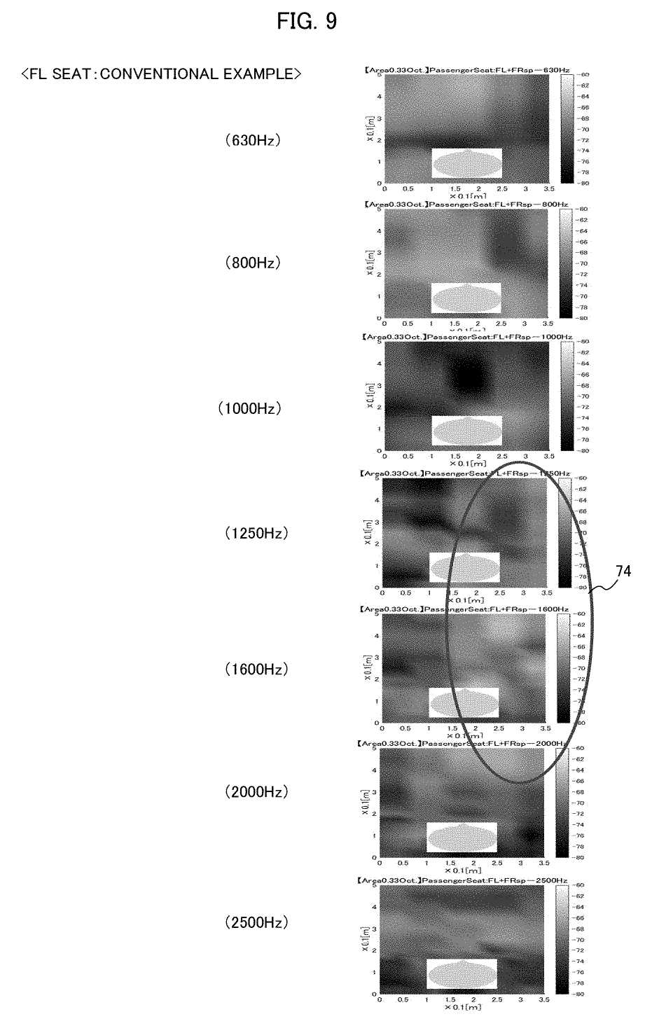

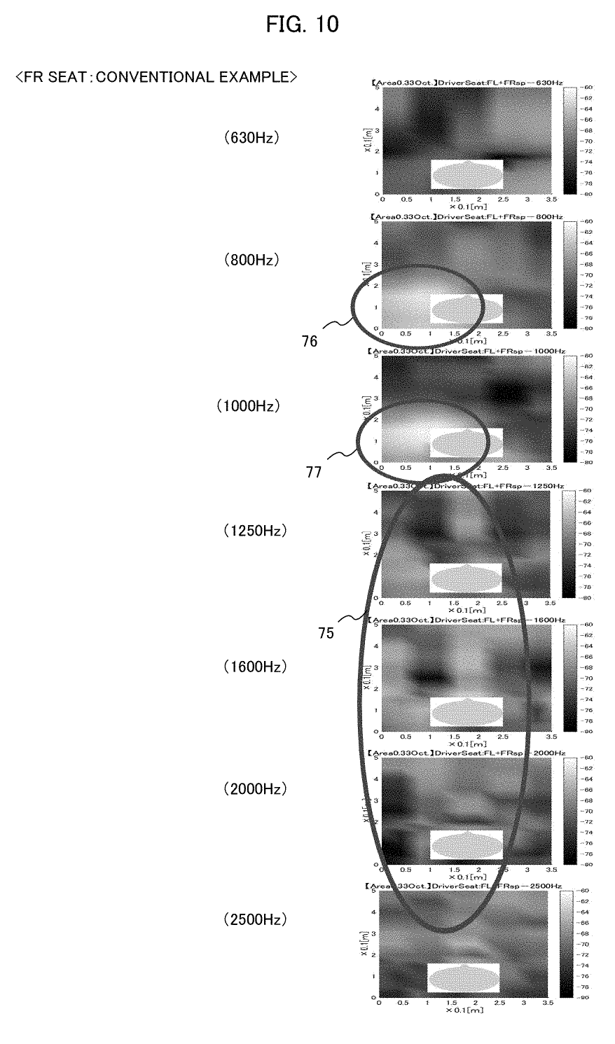

FIGS. 9 and 10 illustrates sound pressure distributions in each frequency band in the vehicle interior sound field after correction by the conventional example. FIG. 9 illustrates the sound pressure distributions at the FL seat, and FIG. 10 illustrates the sound pressure distributions at the FR seat. As described with reference to FIGS. 6 and 7, in the sound pressure distributions before correction, the sound pressure level is high in the frequency band 1250-1600 Hz for the FL seat, and the sound pressure level is high in the frequency band 800-1600 Hz for the FR seat.

By the correction of the conventional example, the equalizer having the characteristic shown in FIG. 8A lowers the sound pressure level around 1600 Hz. By this, in the sound pressure distributions at the FL seat shown in FIG. 9, the sound pressure level is lowered in the frequency band 1250-1600 Hz shown by the ellipse 74. Similarly, in the sound pressure distributions at the FR seat shown in FIG. 10, the sound pressure level is lowered in the frequency band 1250-1600 Hz shown by the ellipse 75. However, for the FR seat, as shown by the ellipses 76 and 77, there still remains a high sound pressure area near the side of the head in the frequency band 800-1000 Hz. Namely, it is understood that the method of the conventional example cannot control the sound pressure level in a certain area. This is because, since the method of the conventional example determines the controlled band based on the frequency characteristic in the vehicle interior sound field, the controlled band may be deviated from the frequency band that should be originally controlled, due to the influence of the peak of the reflected sounds included in the frequency characteristics.

Next, the method of the embodiment will be described. As described above, by the method of the embodiment, the controlled band is determined based on the vehicle compartment layout, i.e., the distances from the left and right speakers FL and FR to the listening positions of the left and right seats. Specifically, the method of the embodiment determines the frequency band having a center frequency of approximately 1150 Hz as the controlled band based on the equation (2), and uses the equalizer which attenuates the sound signal around 1150 Hz as shown in FIG. 8B. Since the characteristic shown in FIG. 8B is different from the characteristic shown in FIG. 8A in the frequency band in which the sound signal is attenuated, the attenuation width and the attenuation amount are the same.

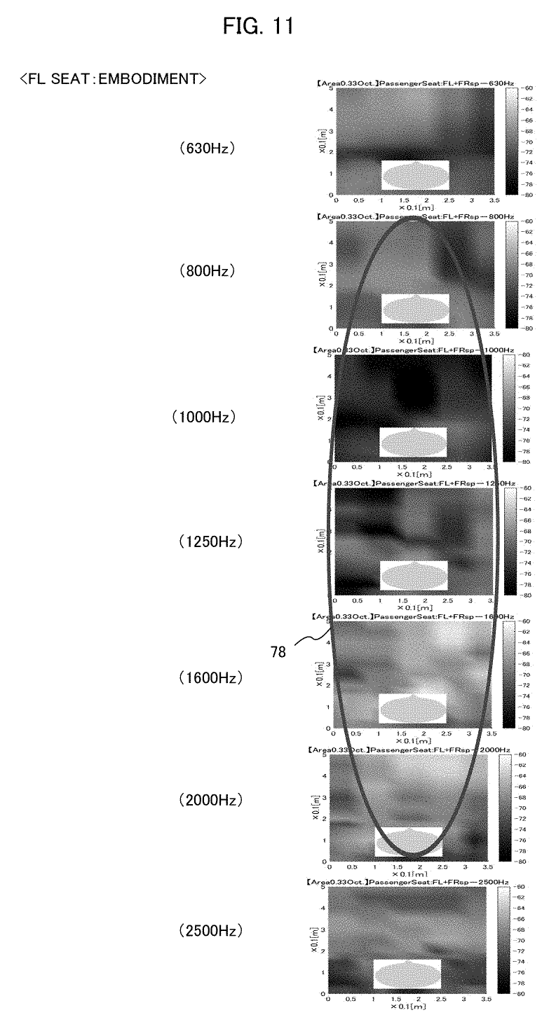

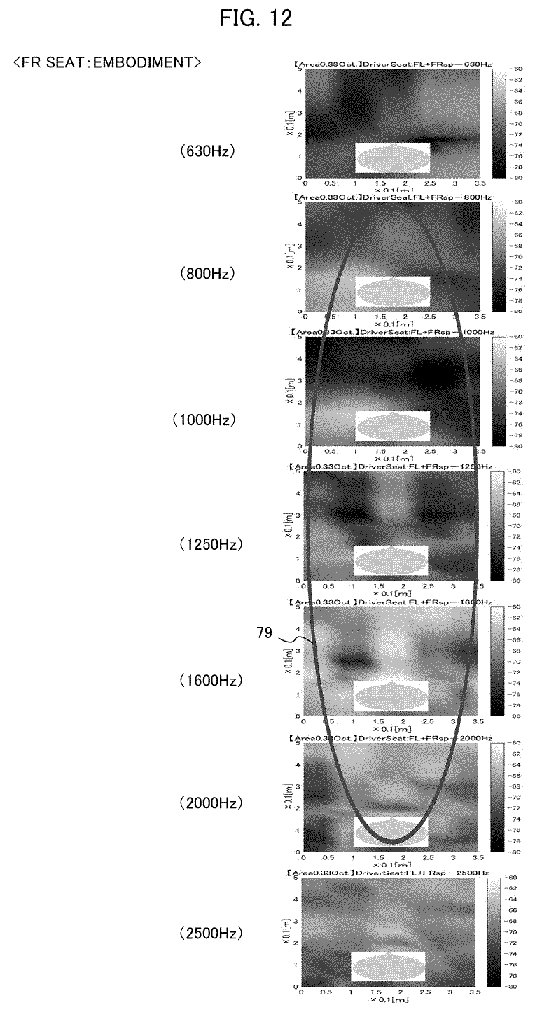

FIGS. 11 and 12 illustrate sound pressure distributions in each frequency band in the vehicle interior sound field after correction by the embodiment. FIG. 11 illustrates the sound pressure distributions at the FL seat, and FIG. 12 illustrates the sound pressure distributions at the FR seat. By the method of the embodiment, in the sound pressure distributions at the FL seat shown in FIG. 11, the sound pressure level is lowered in the frequency band 1250-1600 Hz shown by the ellipse 78. Similarly, in the sound pressure distributions at the FR seat shown in FIG. 12, the sound pressure level is lowered in the frequency band 800-1600 Hz shown by the ellipse 79. Namely, in the sound pressure distributions at the FR seat, the sound pressure level is lowered in the broad frequency band 800-1600 Hz. In this way, the method of the embodiment determines the frequency band in which the sounds outputted from the two speakers become in-phase as the controlled band based on the vehicle compartment layout, and controls the sound pressure level in the frequency band. Therefore, it becomes possible to control the sound volume at the left and right seats in the broad frequency band at the same time, without the need of complicated calculation.

In the above example, the sound pressure distributions are evaluated by using the center point of the listening positions at the FL seat and the FR seat as the evaluation point. Instead, the sound pressure distributions may be evaluated by using the sum (both ear sum) of the sound pressure levels at the left and right ears of the listeners sitting on the FL seat and the FR seat.

(Configuration of Equalizer)

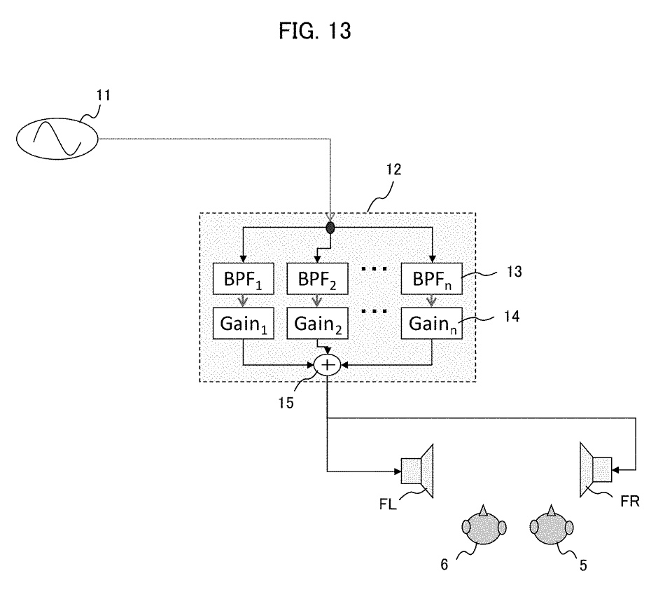

FIG. 13 illustrates an example of a configuration of the equalizer 12. In this example, the equalizer 12 includes bandpass filters 13 and amplifiers 14 provided for each of a plurality of frequency bands, and an adder 15. The sound signal inputted from the sound source 11 is divided into signals of plural frequency bands by the bandpass filters 13, and supplied to the amplifiers 14 corresponding to each frequency band. Each amplifier 14 amplifies the inputted signal by an amplitude set for each frequency band, and outputs it to the adder 15. For example, in a case where the characteristic of the equalizer 12 is set as shown in FIG. 8B, the amplifier 14 corresponding to the frequency band having the center frequency 1000 Hz is set to attenuate the input signal. The adder 15 adds the signals inputted from the amplifiers 14 and supplies the added signal to the left and right speakers FL and FR. Thus, the equalizer 12 controls the sound volume in the controlled frequency band.

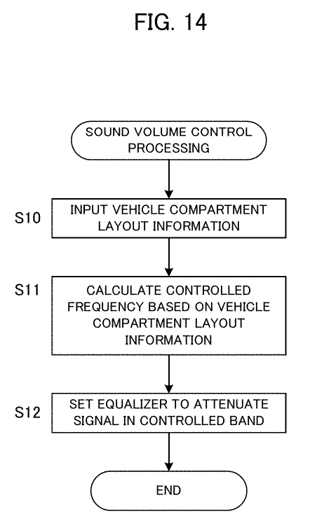

FIG. 14 is a flowchart of sound volume control processing by the sound volume control device 10. This processing is realized by the controller 16 shown in FIG. 2, which executes a program prepared in advance. First, the controller 16 receives the vehicle compartment layout information that the user inputs to the input unit 17 (step S10). For example, the vehicle compartment layout information includes the distance “DL” from the left speaker FL to the driver's seat 2a and the distance “DR” from the right speaker FR to the driver's seat 2a. Next, the controller 16 calculates the frequency at which the sounds from the left and right speakers become in-phase at the left and right seats, i.e., the controlled frequency Fp, based on the vehicle compartment layout information by using the equation (1) (step S11). Then, the controller 16 determines the controlled frequency band having a predetermined width based on the controlled frequency Fp thus calculated, and inputs it to the equalizer 12 (step S12). Thus, the equalizer 12 is set to attenuate the sound signal in the frequency band having the controlled frequency Fp as a center frequency. In a preferred example, the frequency band having the controlled frequency Fp as the center frequency and having the range of ±⅙ octave, i.e., the range of ⅓ octave is determined as the controlled frequency band, and the equalizer 12 is set to attenuate the sound signal in the controlled frequency band thus determined.

(Application)

Next, an application of the above embodiment will be described. In the above embodiment, since the peak of the sound pressure level is generated around 1000 Hz as shown in FIG. 4, the signal of that frequency band is attenuated by the equalizer 12 having the characteristic shown in FIG. 8B. Here, as shown in FIG. 4, a dip of the sound pressure level is generated in the frequency band around 600 Hz. Therefore, in addition to attenuate the sound signal around 1000 Hz, the sound signal around 600 Hz may be slightly amplified so as to compensate for the dip around 600 Hz.

In the above embodiment, while the frequency band in which the sounds from the two speakers become in-phase at the left and right seats is determined as the controlled frequency band, actually there are two frequency bands in which the sounds from the two speakers become in-phase at the left and right seats. For example, if the sounds from the two speakers become in-phase in the frequency band 1000 Hz, they also become in-phase in the frequency band 2000 Hz. However, when the frequency band becomes high, since the width of the interference fringe generated by the sounds from the two speakers becomes smaller than the head width (normally, about 16 cm) of a general listener, the effect of controlling the sound pressure level in view of a hearing sense of the listener becomes smaller compared with the case of the frequency band 1000 Hz. Therefore, even if the sounds from the two speakers become in-phase, it is unnecessary to control the sound pressure level in a frequency band higher than a predetermined frequency (e.g., 2000 Hz).

[Modified Example]

While the sound signal outputted from the sound source 11 is supplied to the equalizer 12 as it is in the above embodiment, there is known a system in which at least one of the output signals from the sound source is outputted after phase processing. In such a system, the frequency band in which the sound signals outputted from the two speakers after the phase processing become in-phase at the listening positions of the left and right seats maybe set as the controlled frequency band.

### INDUSTRIAL APPLICABILITY

This invention can be used for a sound reproduction device loaded on a vehicle.

### BRIEF DESCRIPTION OF REFERENCE NUMBERS

1 Vehicle

2a, 2b Seat

10 Sound control device

11 Sound source

12 Equalizer

16 Controller

17 Input unit

FL, FR Speaker

1. A sound volume control device connected to output units symmetrically arranged with respect to left and right seats of a vehicle, comprising:
an estimation unit configured to estimate a common frequency to be controlled when sounds outputted from each of the output units are listened to at each of listening positions of the left and right seats; and
a correction unit configured to correct a level at the common frequency based on the common frequency.

2. The sound volume control device according to claim 1, wherein the estimation unit estimates, as the common frequency, a frequency at which direct sounds of the sounds outputted from each of the output units become in-phase at each of the listening positions of the left and right seats.

3. The sound volume control device according to claim 1, wherein the estimation unit estimates the common frequency based on distances from each of the output units to one of the listening positions of the left and right seats.

4. The sound volume control device according to claim 3, wherein the estimation unit estimates the common frequency by an equation based on a difference of the distances.

5. The sound volume control device according to claim 1, further comprising a phase controller configured to control phases of the sounds outputted from each of the output units to be in-phase at the left and right seats.

6. The sound volume control device according to claim 1, wherein the correction unit corrects the level in a frequency band having a predetermined range from the common frequency.

7. The sound volume control device according to claim 1, wherein the correction unit does not correct the level for the common frequency higher than a predetermined frequency.

8. A sound volume control method executed by a sound volume control device connected to output units symmetrically arranged with respect to left and right seats of a vehicle, comprising:
estimating a common frequency to be controlled when sounds outputted from each of the output units are listened to at each of listening positions of the left and right seats; and
correcting a level at the common frequency based on the common frequency.

9. A non-transitory computer-readable medium storing a program executed by a sound volume control device including a computer and connected to output units symmetrically arranged with respect to left and right seats of a vehicle, the program causing the computer to function as:
an estimation unit configured to estimate a common frequency to be controlled when sounds outputted from each of the output units are listened to at each of listening positions of the left and right seats; and
a correction unit configured to correct a level at the common frequency based on the common frequency.

10. (canceled)
